(19) United States
(12) Patent Application Publication
(10) Pub. No.: US 2010/0084255 A1
(43) Pub. Date: Apr. 8, 2010

(54) Liquid purifying device

(75) Inventor: Michael D. Shumway, American Fork, UT (US)

Correspondence Address: Tao Group, Inc., 10 South 300 East, American Fork, UT, 84003, US

(73) Assignee: Tao Group, Inc.

(21) Appl. No.: 12/287,075

(22) Filed: Oct. 6, 2008

(51) Int. Cl. B01D 1/22

(52) U.S. Cl. 202/185.1

(57) ABSTRACT

A liquid purifying device for separation and removal of volatile contaminants from liquids, and more particularly relating to such a device that is secured directly to the liquid source and utilizes improvements which allows the device to operate through a wide variety of angles from horizontal to vertical.

### BACKGROUND OF THE INVENTION

1. Field of the Invention

The present invention relates to a device for purifying liquids, and particularly relates to a liquid purifying device utilizing the process of distillation/evaporation of volatile contaminants contained within a liquid to separate and remove such volatile contaminants from the contaminated liquid, and more particularly relates to such a device that utilizes an improved design which allows the device to operate through a wide variety of angles from horizontal to vertical.

2. Description of the Prior Art

There presently exist some few distillation-type liquid separation and reclamation devices for distillation/evaporation and removal of volatile contaminants from contaminated liquid. Most of these units utilize what is called the thin-film evaporation process wherein the contaminated liquid is passed over a heated flat horizontal surface (evaporation plate), the theory being that the heat will cause the contaminated liquid to flow in a “thin film” on the heated flat horizontal surface creating an ideal situation wherein the volatile contaminants within the contaminated liquid will be driven out of the liquid through the processes of boiling and vaporization The liquid, which now contains less contaminate, continues through the device and returns to the source of the liquid for further use. In addition, most of these thin-film evaporation-type distillation units generate the heat required to drive this purification process through the use of a heating element (generally electric) for maintaining the evaporation plate at the desired temperature. Typical examples of these types us units are shown in U.S. Pat. Nos. 1,718,800, 2,472,717, and 4,006,084.

One of the problems with these prior art thin-film evaporation-type distillation units is that the heating element is in the general vicinity of the contaminants, which may be combustible, creating a potentially explosive environment. Another problem of the prior art is they are complicated and expensive to manufacture and difficult to service.

Additionally, most of these units require external mounting equipment and a convenient location for the placement of these devices. Liquid distillation/evaporation units of this type are shown in U.S. Pat. Nos. 1,718,800, 2,472,717, 3,198,104, 4,006,084, 4,115,201, 4,369,110, 4,717,474. All these patents disclose liquid purifying device designs which are mounted remotely from the source of the liquid. U.S. Pat. No. 6,818,046 discloses the use of the existing filtration system to effect a mounting system for this liquid purifying device, but this system only operates when mounted to an oil filter system where the evaporation surface is in a horizontal orientation. This is an insufficient mounting orientation given the number of oil filter mounts which do not allow for this device to be mounted in its required horizontal orientation.

There remains a need for an efficient evaporation apparatus that is small enough for use in a wide variety of applications while not being limited to a horizontal mounting orientation. Therefore there remains a need for a Liquid Purifying Device which allows the Liquid Purifying Device to be positioned in an optimal position for installation while retaining liquid purifying capabilities. However, at the time the present liquid purifying device was made, it was not obvious to those of ordinary skill in the art how those needs could be fulfilled, in view of the prior art as a whole.

### OBJECT OF THE INVENTION

It is therefore an object of the present invention to provide a liquid purifying device that is small and compact, and conveniently fastens to a liquid filter mounting system in a variety of different mounting orientations.

### SUMMARY OF THE INVENTION

The liquid purifying device (10) of the present invention is utilized for separating and removing volatile contaminants from liquids. The liquid purifying device (10) comprises a distillation/evaporation chamber positioned essentially between the liquid source (34) and a liquid filter (32). (The liquid source and liquid filter are not part of the present invention). A portion of the contaminated liquid is passed through the liquid metering orifice (26), whereupon the liquid enters the distillation/evaporation chamber (22). Upon entering the distillation/evaporation chamber (22) the liquid spreads in a thin film, thereby effecting the distillation/evaporation process. The heat required to drive this distillation/evaporation process is derived from the liquid source and the liquid itself, which in the preferred embodiment would be an internal combustion engine at operating temperatures, although other types of liquid sources and temperatures are within the scope of the invention. The entire liquid purifying device (10) is mounted to and receives heat from the liquid and the liquid source. Since the heat for distillation/evaporation of the volatile contaminants in the liquid is provided by the heated liquid and the liquid source, there is no necessity for a separate heating element to maintain the vaporization temperature of the distillation/evaporation chamber, which eliminates any potential explosion due to combustible vapors coming into contact with a heating element.

This distillation/evaporation process is based on the well known principles of the thin-film evaporation process, wherein a liquid is spread into a thin film and heated, thus allowing trapped volatile elements such as water, fuel, trapped gases, etcetera, within the liquid to be evaporated and vented outside the liquid purifying device.

This liquid purifying device is typically used with an internal combustion engine, whereby a small amount of contaminated engine oil communicating between the engine and filter which passes through the device is diverted and processed within the liquid purifying device, whereupon the volatile contaminants are vaporized and removed from the oil. The processed lubricating oil is then returned to the engine oil pan through the purified liquid exit (24).

In addition, the liquid to be purified communicates to the liquid filter through a plurality of liquid communicating conduits (12), such that these conduits allow the liquid to flow to and from the liquid filter across the span of the current invention thereinbetween with little or no impedance in overall liquid flow. This allows the liquid purifying device to effectively utilize the existing liquid filter mounting system to facilitate its own mounting while simultaneously providing a convenient source of liquid to the liquid purifying device while not altering the operation of the engine lubricating system.

A first feature of this liquid purifying device is an improved mounting method achieved using the existing liquid filter mounting system wherein the filter needs not be in a vertical orientation, but can be in any orientation from horizontal to vertical. This utilization brings the benefits of a compact installation with a direct liquid source and convenient placement with minimum difficulty of installation and maintenance. Another benefit of this design is the efficient use of the heat inherent to most liquid sources to heat the distillation/evaporation chamber evenly and effectively without the need of any additional heat source, which eliminates the need for potentially dangerous heating elements while improving efficiency and reducing manufacturing costs.

Thus it is understood that a primary object of this liquid purifying device is to advance the art of liquid purifying by providing a device with is easily and conveniently mounted from a horizontal to vertical orientation, simple to install, and providing safer and more reliable operation.

These and other important objects, features and advantages of this liquid purifying device will become apparent as this description proceeds.

This liquid purifying device accordingly comprises the features of construction, combination of elements, and arrangement of parts that will be exemplified in the construction hereinafter set forth, and the scope of this liquid purifying device will be indicated in the claims.

### BRIEF DESCRIPTION OF THE DRAWINGS

Other objects of this liquid purifying device will appear in the following description and claims, reference being made to FIGS. 1-16 forming a part of the specification wherein like reference characters designate corresponding parts.

FIG. 1 is a horizontal sectional view of the preferred embodiment of the liquid purifying device of the present invention.

FIG. 2 is a vertical sectional view of the preferred embodiment of the liquid purifying device of the present invention.

FIG. 3 is a top plan view of the preferred embodiment of the liquid purifying device.

FIG. 4 is a bottom plan view of the preferred embodiment of the liquid purifying device.

FIG. 5 is a transparent top plan view of the preferred embodiment of the liquid purifying device.

FIGS. 6-10 are a representation of the range of the various possible orientations of the Liquid Purifying Device.

FIG. 11 is a horizontal isometric view of a second embodiment of the Liquid Purifying Device.

FIG. 12 is a vertical isometric view of a second embodiment of the Liquid Purifying Device.

FIG. 13 is a transparent top plan view of a second embodiment of the liquid purifying device.

FIG. 14 is a horizontal isometric view of a third embodiment of the Liquid Purifying Device.

FIG. 15 is a vertical side view of a third embodiment of the Liquid Purifying Device.

FIG. 16 is a transparent top plan view of a third embodiment of the liquid purifying device.

### LIST OF REFERENCE NUMERALS

10 Liquid purifying device.
12 Liquid communicating conduits.
14 Liquid purifier to liquid source and liquid filter attachment means.
16 Liquid seals. (For illustrative purposes only. Not part of the present invention)
18 Distillation/evaporation chamber lid.
20 Vapor vent. (Only one Vapor Vent is required although multiple Vapor Vents are within the scope of this invention)
22 Distillation/evaporation chamber.
24 Purified liquid exit.
26 Liquid metering orifice.
28. Liquid exit plug.
32 Liquid filter. (For illustrative purposes only. Not part of the present invention)
34 Liquid source. (For illustrative purposes only. Not part of the present invention)
36 Distillation/evaporation chamber lid attachment means (bolt, screw, or other similar method).
38 Distillation/evaporation chamber lid attachment means (interference fit).

### DESCRIPTION OF SPECIFIC EMBODIMENT

The liquid purifying device of the present invention has application in many environments. For example, the device may be used to supplement factory filter systems in internal combustion engines in both mobile and stationary applications. It is also contemplated that the present liquid purifying device will have application in hydraulic systems, and in industrial applications wherever hydraulic liquid (oil), cutting (machining) oil, drilling liquid, cooking oil, cleaning liquids, cooling/heating liquids, etc. are used. For purposes of description and explanation of the concept of the liquid purifying device, however, and without limiting the concept or application of the invention, the liquid purifying device will be described in an application of an oil-lubricated internal combustion engine.

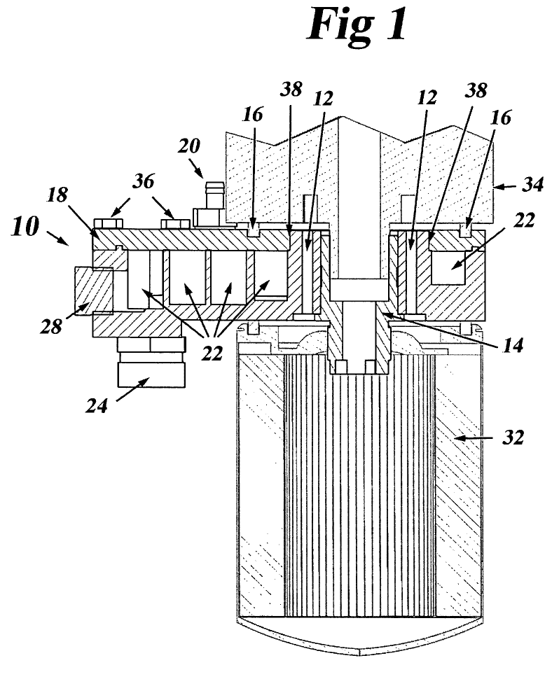

Turning now to the drawings, and initially to FIG. 1, the liquid purifying device in general is denoted by the numeral 10. Looking first at the liquid purifying device to liquid source and liquid filter attachment means (14) and liquid communication conduits (12), we see that the device is secured to the liquid source by the liquid source attachment means (14) with a liquid filter (32) attached at the opposing end of (14). In practice, the liquid source attachment means (14) is a threaded boss or insert which engages to the internal combustion engine, holding and securing the device in place, and with threads at the opposing end of (14) to engage and secure a liquid filter (32) to the liquid purifying device with the liquid communication conduits (12) allowing free communication of engine oil between the internal combustion engine and the liquid filter in the customary manner, with the device located thereinbetween. This allows the liquid purifying device to be mounted in-between the engine and the oil filter while retaining the complete functionality of the oil filter with the added capabilities of the liquid purifying device (10).

The liquid purifying device (10) includes a liquid metering orifice (26) for conducting oil to the distillation/evaporation chamber (22) while simultaneously moderating the oil delivery rate to between 0.5 and 20 gallons per hour, although other flow rates are within the scope of this liquid purifying device. Metering orifices of the type depicted here are well known and in common use.

The specific apparatus for separating and removing the volatile contaminates from the oil is the distillation/evaporation chamber (22). The distillation/evaporation chamber is simply a chamber of the proper shape and dimensions such as to promote the spreading of the oil into a thin film, and includes a liquid oil metering orifice (26), a vapor vent (20), and a purified oil exit (24). The distillation/evaporation chamber is enclosed by the distillation/evaporation chamber lid (18), which is secured by the distillation/evaporation chamber lid attachment means (36), press fit lid attachment means (38), or any combination hereto. The lid may also be attached through the means of welding, bonding, etc. which attachment means are well understood and in common use. In the preferred embodiment as observed in FIG. 1, the distillation/evaporation chamber (22), oil metering orifice (26), purified oil exit (24), and vapor vent (20) may all be incorporated into a single housing. The simplicity of this design is one of its greatest strengths.

The dimensions of the distillation/evaporation chamber may vary according to the desired liquid flow rate and the liquid to be purified. FIG. 1 illustrates the preferred embodiment wherein the distillation/evaporation chamber has a height roughly equivalent to one and one-half the width of the chamber, although other width to height ratios and dimensions are within the scope of the invention.

Referring again to FIG. 1, it can be seen that the purified liquid exit (24) communicates the purified oil out from the distillation/evaporation chamber (22) to a location outside the chamber (which in the case of installation on an internal combustion engine, the engine lubricating oil would be communicated to an oil return line which returns the oil to the engine). Additionally, it can also be seen that vapor vent (20) communicates vaporized contaminates from within the distillation/evaporation chamber (22) to a location outside the chamber.

### Operation of the Preferred Embodiment

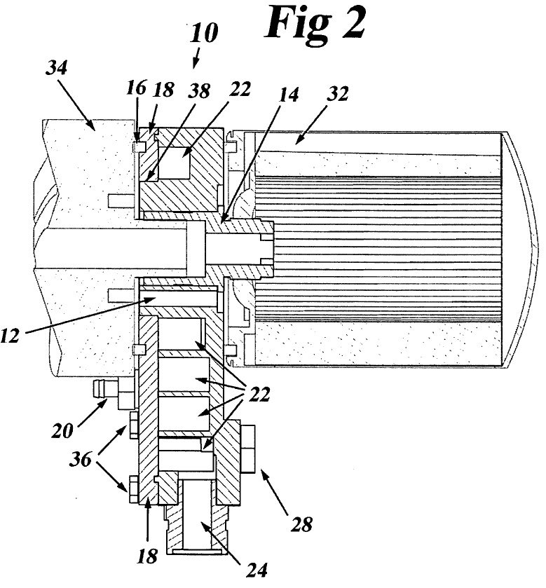

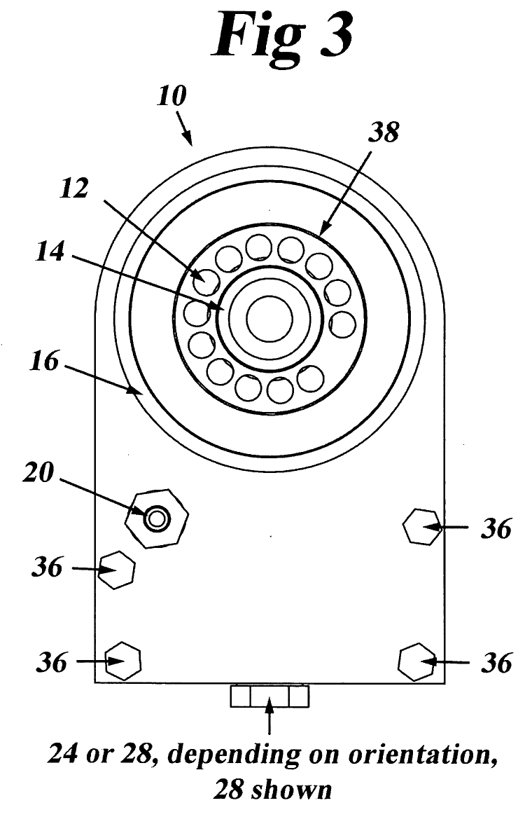

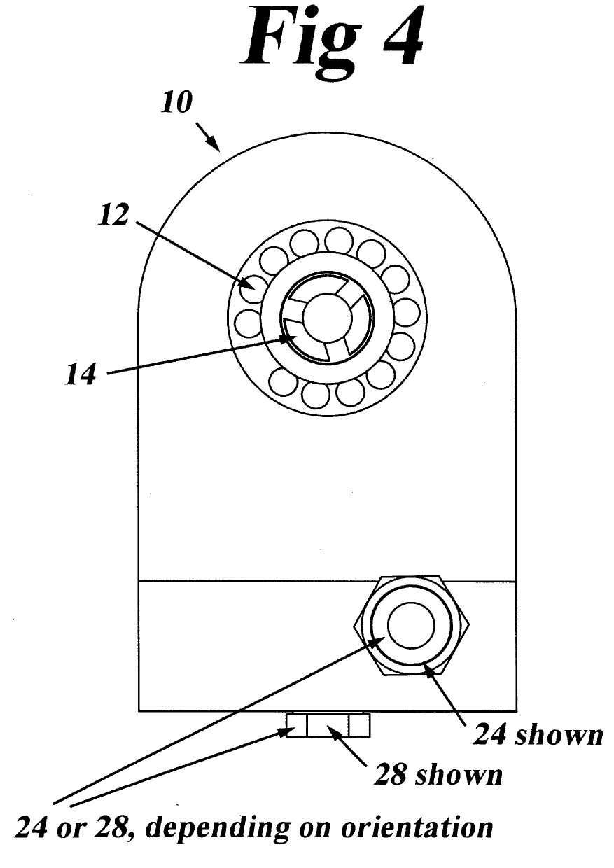

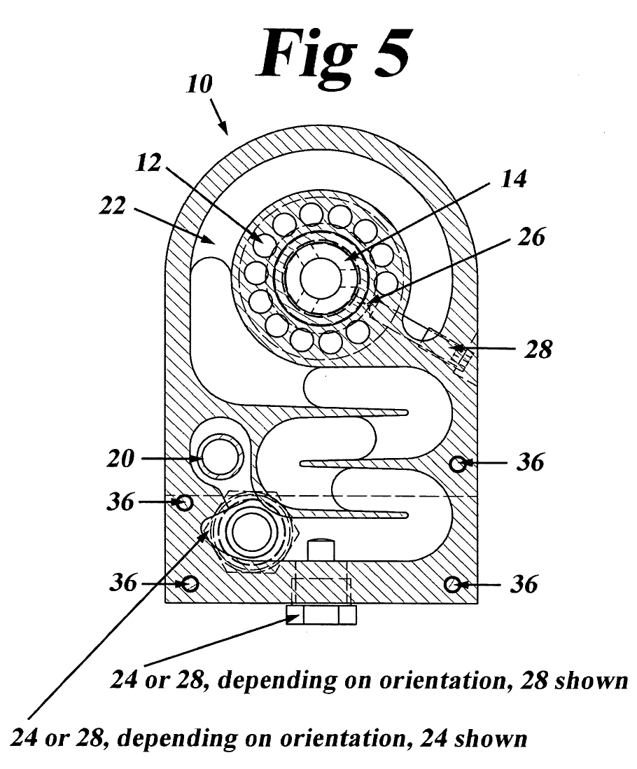

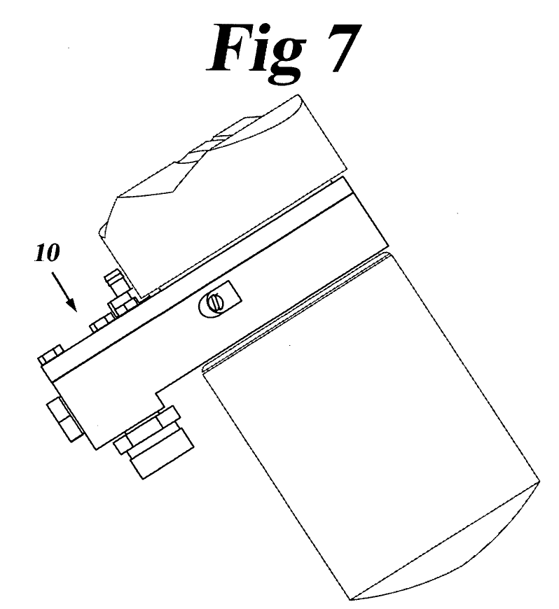

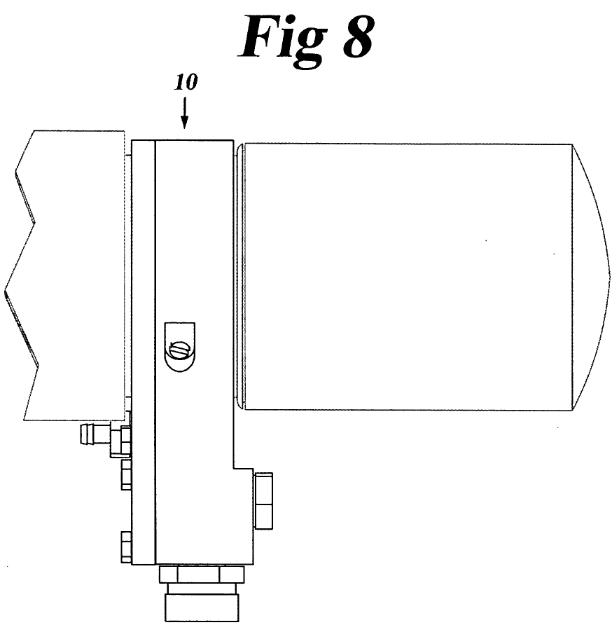

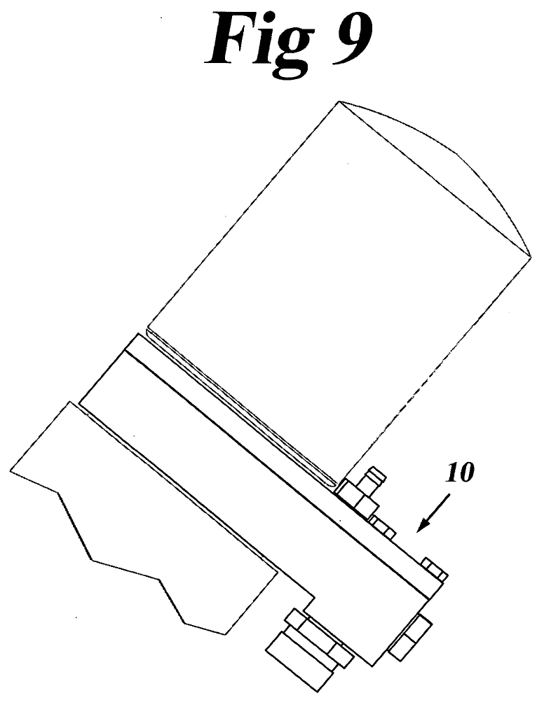

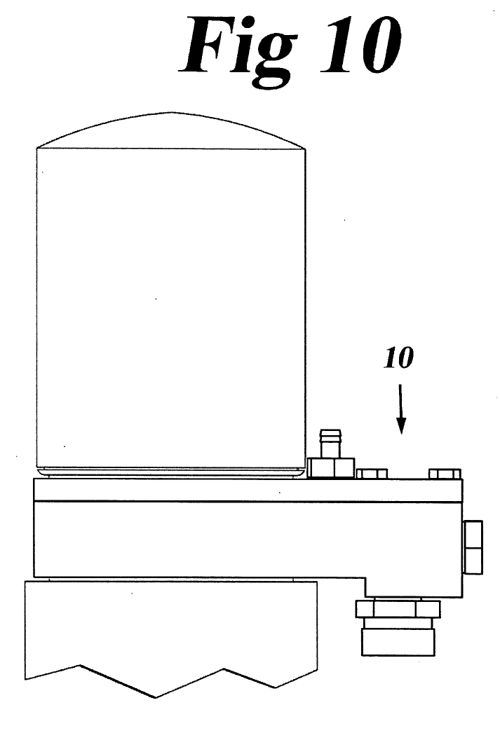

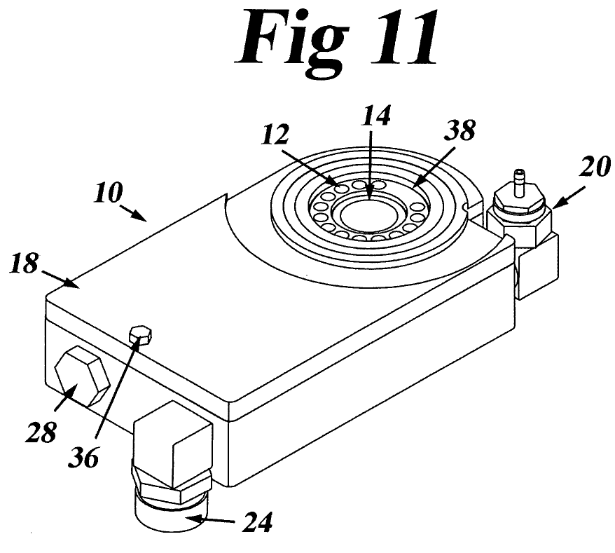

In the preferred embodiment as illustrated by FIGS. 1-10, most of the oil passes unimpeded from the engine and through the oil filter by use of the liquid communication conduits (12), allowing the oil filter to operate and be maintained in the customary manner.

A small amount of oil enters the distillation/evaporation chamber (22) through the liquid metering orifice (26), which is in communication with the liquid purifier to liquid source and liquid filter attachment means (14). This oil, upon entering the distillation/evaporation chamber (22) may experience a sudden pressure drop due to the passage of the oil from the pressurized engine oil supply through the metering orifice to the distillation/evaporation chamber, which is at a pressure lower than the oil supply. This sudden drop of pressure facilitates evaporation of volatile contaminants that have been emulsified in the oil.

As the oil flows through the distillation/evaporation chamber (22), it flows in a thin-film, which effects the thin-film evaporation of the volatile contaminants from the oil.

This thin-film evaporation process is greatly enhanced by the direct contact of the device to an engine block so as to allow the transfer of more heat from the engine to the device.

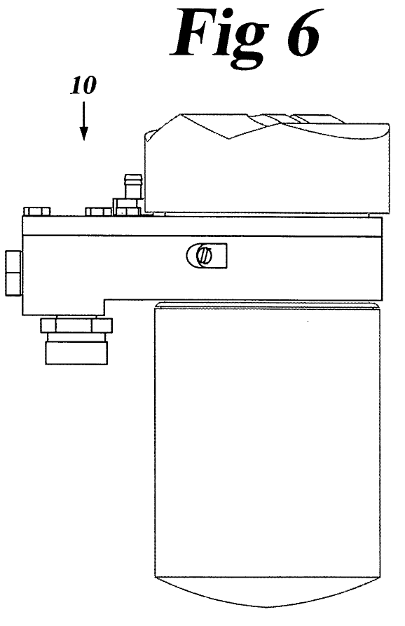

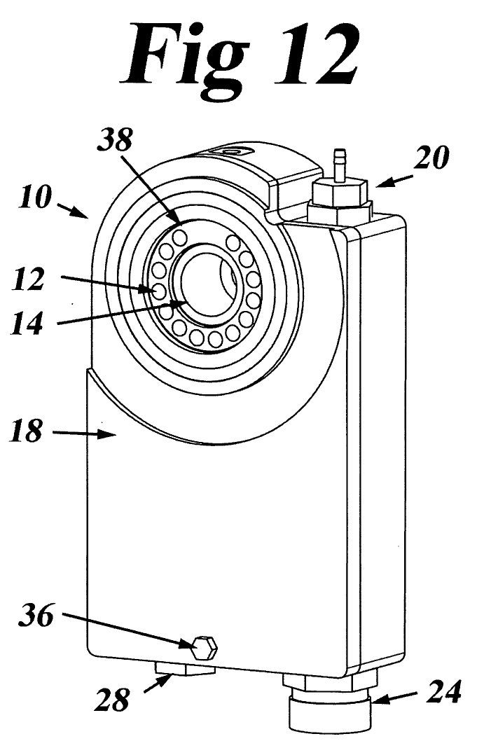

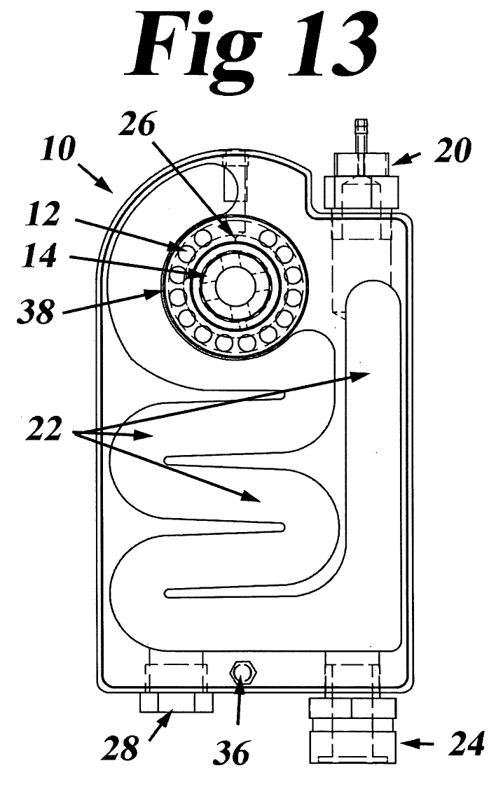

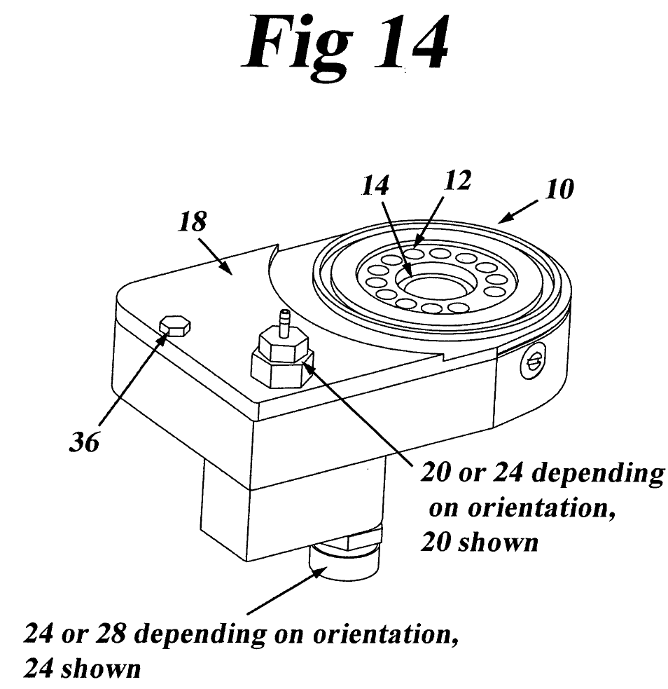

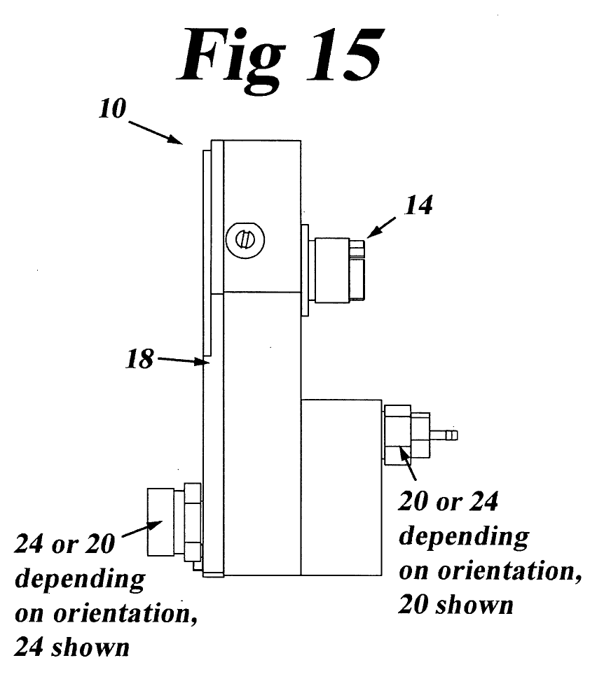

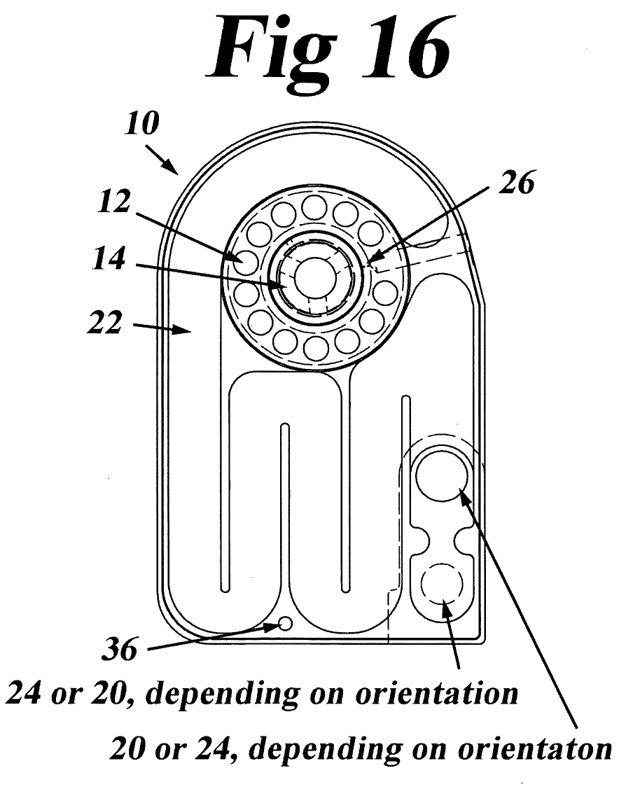

Those skilled in the art will appreciate that the distillation/evaporation chamber need not be horizontal while oil is being processed therein and will appreciate that the design of the distillation/evaporation chamber allows all positions as shown in FIGS. 6-10, 12, 14, and 15. Additionally, as the oil flows through the distillation/evaporation chamber, the natural vibrations inherent in most liquid sources, and in particular internal combustion engines, inputs physical forces into the flow of the oil resulting in a churning and lapping action of the oil within the distillation/evaporation chamber (22) which evenly coats the interior of the chamber with a thin film of oil, thereby causing increased efficiency in evaporation of the volatile contaminants from within the oil.

When the oil has flowed across the distillation/evaporation chamber, the oil exits the device by way of purified liquid exit (24) to be returned to the engine. As the various volatile contaminants within the oil vaporize, this vapor requires a means of exhaust. Because of the fact that the distillation/evaporation chamber forms essentially a closed system, the volume within the distillation/evaporation chamber remains constant. Therefore, as the various contaminants vaporize and expand, the vapor is forced through the vapor vent (20) by means of vapor pressure in a manner similar to how water is forced out of a boiling teapot.

This liquid purifying device is clearly new and useful. Moreover, it was not obvious to those of ordinary skill in the art at the time it was made, in view of the prior art considered as a whole as required by law.

It will thus be seen that the objects set forth above, and those made apparent from the foregoing description, are efficiently attained and since certain changes may be made in the above construction without departing from the scope of this liquid purifying device, it is intended that all matters contained in the foregoing construction or shown in the accompanying drawings shall be interpreted as illustrative and not in a limiting sense.

It is also to be understood that the following claims are intended to cover all of the generic and specific features of this liquid purifying device herein described, and all statements of the scope of this liquid purifying device which, as a matter of language, might be said to fall therebetween.

I claim:

1. Apparatus for separating and removing volatile contaminants from a liquid, comprising:
a distillation/evaporation chamber comprising at least one sidewall;
an inlet to said distillation/evaporation chamber to allow flow of liquid into said distillation/evaporation chamber from a liquid source outside said distillation/evaporation chamber;
said distillation/evaporation chamber incorporating means which permits effective operation through a range of orientations from horizontal to vertical;
an outlet or outlets from said distillation/evaporation chamber for flow of liquid to outside the distillation/evaporation chamber;
a vent or vents in the distillation/evaporation chamber to vent airborne contaminates therefrom;
a plurality of liquid communication channels located adjacent to said distillation/evaporation chamber for the transmission of liquid; and
an attachment means for directly mounting said distillation/evaporation chamber to a liquid source.

2. Apparatus for separating and removing volatile contaminants from a liquid, comprising:
a housing encompassing a chamber;
said chamber incorporating means allowing operation over a wide range of angles;
an attachment means for directly mounting said housing to a liquid source;
an inlet to said chamber to allow flow of liquid into said chamber from a liquid source outside said chamber;
an outlet from said chamber for flow of liquid to outside said chamber; and
a vent in said chamber to vent airborne contaminates therefrom.

3. Apparatus as set forth in claim 2, further comprising;
a plurality of liquid communication conduits extending through said housing for the transmission of liquid to and from a filter and the liquid source.
